(19) United States
(12) Patent Application Publication
(10) Pub. No.: US 2024/0032124 A1
(43) Pub. Date: Jan. 25, 2024

(54) COMPONENT CARRIER CONFLICT MANAGEMENT AT A WIRELESS COMMUNICATION DEVICE WITH MULTIPLE SUBSCRIPTIONS

(71) Applicant: QUALCOMM Incorporated, San Diego, CA (US)

(72) Inventors: Bhargava PEDDIRAJU, Hyderabad (IN); Theeksha ATHOOR PERUMAL, Hyderabad (IN); Debashri BHATTACHARYA, Hyderabad (IN)

(21) Appl. No.: 17/868,518

(22) Filed: Jul. 19, 2022

(51) Int. Cl. H04W 76/16; H04W 8/18; H04W 76/20

(52) U.S. Cl. CPC H04W 76/16; H04W 8/183; H04W 76/20; H04W 88/06

(57) ABSTRACT

A multi-SIM wireless communication device uses various techniques for managing component carrier conflict between different wireless networks. In some aspects, the multi-SIM wireless communication device can indicate to a network entity when a component carrier is muted due to a conflict between carriers of different subscriptions when the device enters a dual-SIM dual active (DSDA) mode or performs DSDA operations.

### TECHNICAL FIELD

The technology discussed below relates generally to wireless communication systems, and more particularly, to managing component carrier conflict at a wireless communication device with multiple subscriptions.

### INTRODUCTION

Wireless devices like cellular phones can include more than one universal subscriber identity module (USIM). USIM can be simply referred to as SIM in this disclosure. USIM and SIM may be used interchangeably throughout this disclosure. Multi-SIM wireless devices have become increasingly popular because of their flexibility in service options and other features. For example, a dual-SIM wireless device may support two different cellular service subscriptions provisioned by the same or different service providers. By using multiple SIMs in the same wireless device, a user can take advantage of different services offered by different subscriptions or cellular service providers. One type of multi-SIM wireless device, referred to as a dual-SIM dual-standby (DSDS) device, may have one active connection using either SIM. Another type of multi-SIM wireless device, referred to as a dual-SIM dual active (DSDA) device, allows simultaneous active connections with the networks/subscriptions corresponding to two different SIMs. In DSDA operations, resource conflicts may occur when both SIMs are in the active mode using one or more active carriers for wireless communication.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A multi-SIM wireless communication device uses various techniques for managing component carrier conflict between different wireless networks. In some aspects, the multi-SIM wireless communication device can indicate to a network entity when a component carrier is muted due to a conflict between carriers of different subscriptions when the device enters a dual-SIM dual active (DSDA) mode or performs DSDA operations.

In one aspect, a method of wireless communication at a user equipment (UE) is provided. The method includes communicating with a first network entity based on a first subscription using a first primary component carrier (CC) and one or more secondary CCs. The method further includes communicating with a second network entity based on a second subscription using a second primary CC. The method further includes muting communication on the one or more secondary CCs in response to a conflict between the second primary CC and at least one of the one or more secondary CCs. The method further includes transmitting a first message to the first network entity, the first message indicating the one or more secondary CCs being muted.

In one aspect, a UE for wireless communication is provided. The UE includes a memory stored with executable code and a processor coupled to the memory. The processor is configured by the executable code to communicate with a first network entity based on a first subscription using a first primary CC and one or more secondary CCs. The processor is further configured to communicate with a second network entity based on a second subscription using a second primary CC. The processor is further configured to mute communication on the one or more secondary CCs in response to a conflict between the second primary CC and at least one of the one or more secondary CCs. The processor is further configured to transmit a first message to the first network entity, the first message indicating the one or more secondary CCs being muted.

In one aspect, a method of wireless communication at a network entity is provided. The method includes communicating with a first UE using a primary CC and one or more secondary CCs. The method further includes receiving a first message from the first UE, and the first message indicates the one or more secondary CCs being muted at the first UE. The method further includes suspending, in response to the first message, communication with the first UE on the one or more secondary CCs.

In one aspect, a network entity for wireless communication is provided. The network entity includes a memory stored with executable code and a processor coupled to the memory. The processor is configured by the executable code to communicate with a first UE using a primary CC and one or more secondary CCs. The processor is further configured to receive a first message from the first UE, and the first message indicates the one or more secondary CCs being muted at the first UE. The processor is further configured to suspend, in response to the first message, communication with the first UE on the one or more secondary CCs.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is an illustration of an example of a radio access network (RAN) according to some aspects.

FIG. 3 is a schematic illustration of an organization of wireless resources in an air interface utilizing orthogonal frequency divisional multiplexing (OFDM) according to some aspects.

FIG. 4 is a conceptual diagram illustrating an example of a wireless network using carrier aggregation according to some aspects.

FIG. 5 is a diagram illustrating an exemplary multi-SIM wireless apparatus according to some aspects.

FIG. 6 is a diagram illustrating a process for managing component carrier conflicts during dual-SIM dual active (DSDA) operations according to some aspects.

FIG. 7 is a diagram illustrating an exemplary bitmap for indicating the status of component carriers during DSDA operations according to some aspects.

FIG. 8 is a diagram illustrating an exemplary process for managing a component carrier (CC) conflict at a multi-SIM wireless apparatus entering a DSDA mode according to some aspects.

FIG. 9 is a diagram illustrating a process for managing CC when exiting the DSDA mode according to some aspects.

FIG. 10 is a diagram illustrating an exemplary process for managing a CC conflict at a multi-SIM wireless apparatus exiting a DSDA mode according to some aspects.

FIG. 11 is a block diagram illustrating an example of a hardware implementation for a network entity according to some aspects.

FIG. 12 is a flow chart illustrating an exemplary process for wireless communication at a network entity according to some aspects.

FIG. 13 is a block diagram illustrating an example of a hardware implementation for a user equipment (UE) according to some aspects.

FIG. 14 is a flow chart illustrating an exemplary process for wireless communication at a UE according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and UE), end-user devices, etc. of varying sizes, shapes and constitution.

Aspects of the present disclosure provide various techniques for managing component carrier conflict between different wireless networks at a multi-SIM wireless communication device. In some aspects, a multi-SIM wireless communication device can indicate to the network entity when a component carrier is muted due to a conflict between carriers of different subscriptions when the device enters dual-SIM dual active (DSDA) mode or performs DSDA operations. As described herein, a network entity may be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

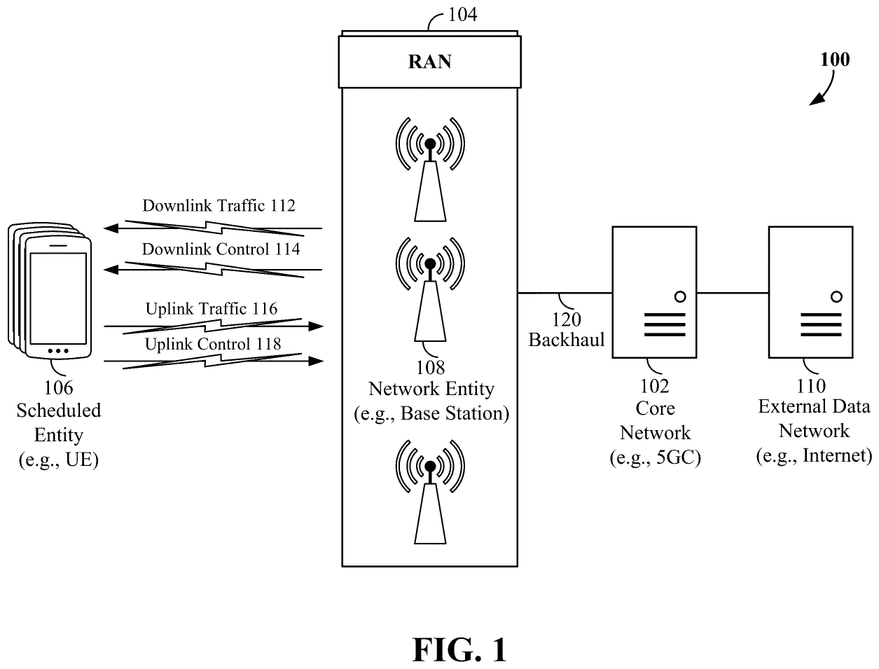

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities (e.g., base stations 108). Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a network entity (e.g., a scheduling entity or a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a network entity (e.g., scheduling entity 108) may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, a network entity (e.g., base stations 108) may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

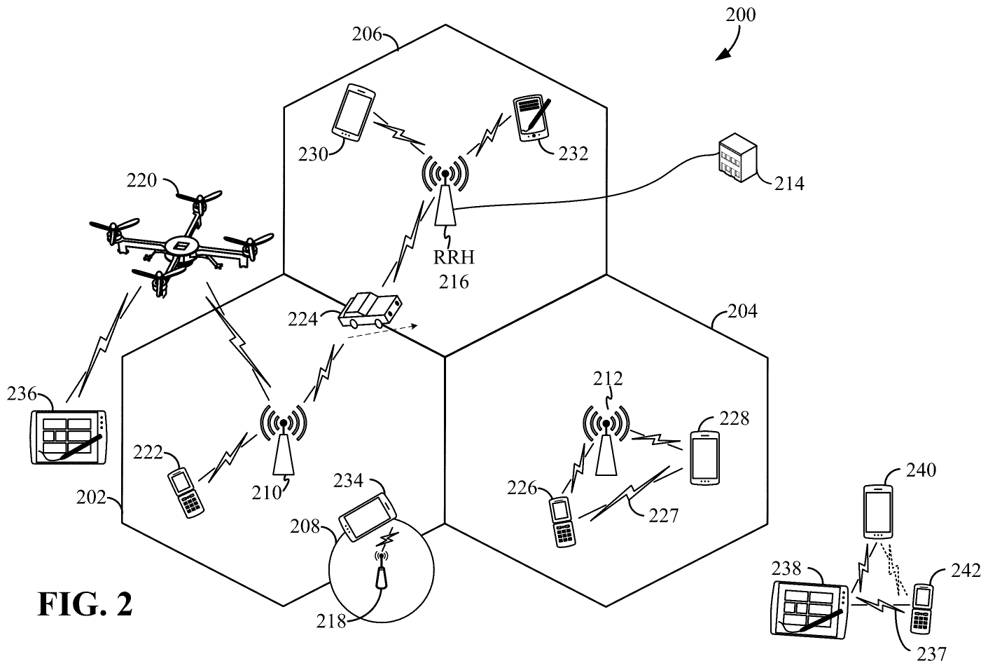

FIG. 2 is a diagram illustrating an example of a RAN 200 according to some aspects. In some examples, the RAN 200 may be the same as the RAN 104 described above and illustrated in FIG. 1. The geographic area covered by the RAN 200 may be divided into cellular regions (cells) that can be uniquely identified by a UE based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, and 218 provide wireless access points to a core network for any number of mobile apparatuses. In some examples, the base stations 210, 212, 214, and/or 218 may be the same as the network entities (e.g., base station/scheduling entity 108) described above and illustrated in FIG. 1.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) and a security anchor function (SEAF) that perform authentication. The SCMF can manage, in whole or in part, the security context for both the control plane and the user plane functionality.

In various aspects of the disclosure, a RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure the strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may hand over the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next-generation communication networks enables the uplink-based mobility framework and improves the efficiency of both the UE and the network, since the number of mobility messages that need to be exchanged between the UE and the network may be reduced.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

The air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

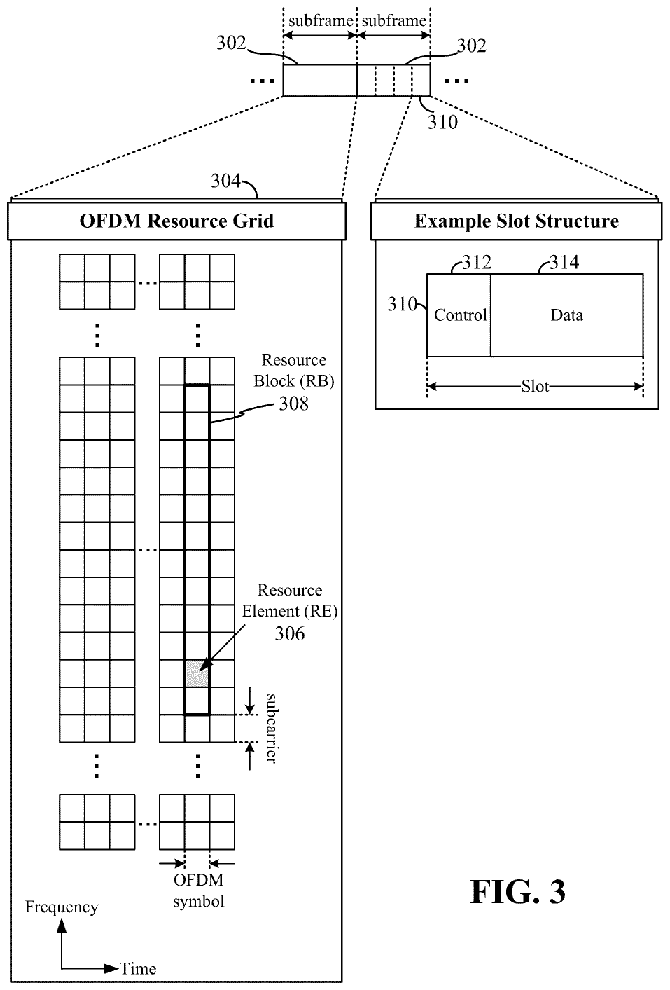

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the physical layer (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity or scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., a request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

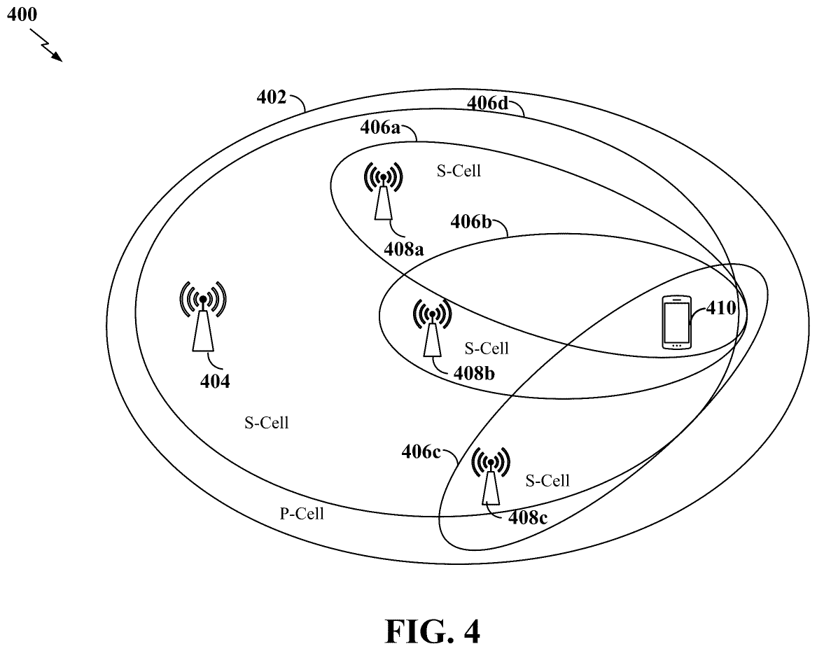

FIG. 4 is a conceptual diagram illustrating an example of a wireless network 400 using carrier aggregation (CA) according to some aspects. The wireless network 400 includes a plurality of cells 402 and 406a-406d. In some examples, one of the cells may be considered a primary serving cell (PCell) 402 and the remaining cells 406a, 406b, 406c, and 406d may be considered secondary serving cells (SCells). The PCell 402 may be referred to as the anchor cell that provides a radio resource control (RRC) connection to the UE. In some examples, the PCell and the SCell may be collocated (e.g., different TRPs at the same geographical location and coupled to the same antenna tower/pole).

When carrier aggregation is configured, one or more of the SCells 406a-406d may be activated or added to the PCell 402 to form the serving cells serving a user equipment (UE) 410. Each serving cell corresponds to a component carrier (CC). The CC of the PCell 402 may be referred to as a primary CC, and the CC of an SCell 406a-406d may be referred to as a secondary CC. The PCell 402 and one or more of the SCells 406 may be served by a respective TRP 404 and 408a-408c that may be a network entity. In the example shown in FIG. 4, SCells 406a-406c are each served by a respective non-collocated TRP 408a-408c. However, SCell 406d is collocated with the PCell 402. Thus, TRP 404 may include two collocated TRPs, each supporting a different carrier. For example, TRP 404 may correspond to a network entity (e.g., a base station) including multiple collocated TRPs. The coverage of the PCell 402 and SCell 406d may differ since different component carriers (which may be in different frequency bands) may experience different path loss.

In some examples, the PCell 402 may add or remove one or more of the SCells 406a-406d to improve the reliability of the connection to the UE 410 and/or increase the data rate. The PCell 402 may be changed upon a handover to another PCell.

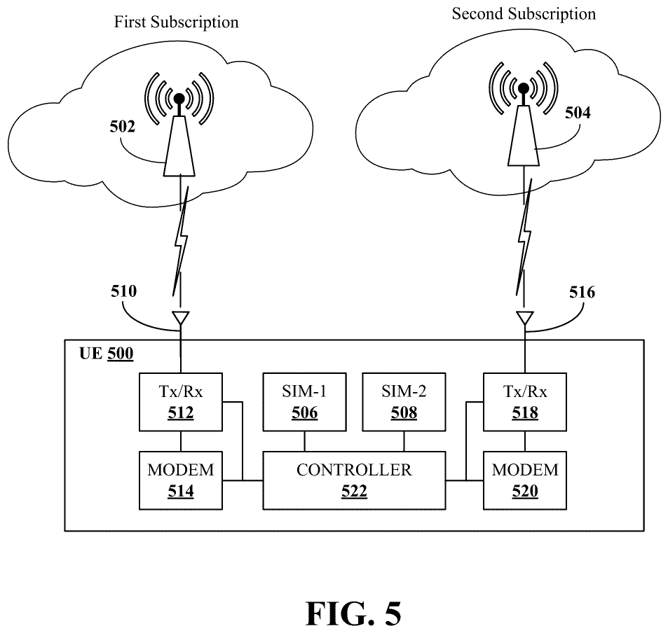

FIG. 5 is a diagram illustrating an exemplary multi-SIM UE 500 in accordance with an aspect of the disclosure. The multi-SIM UE 500 may be any of the UEs or scheduled entities described above in relation to FIGS. 1 and 2. The multi-SIM UE 500 can have two or more physical and/or electronic SIMs that are provisioned to use multiple service subscriptions, for example, a first subscription with a first network (e.g., via a first network entity 502) and a second subscription with a second network (e.g., via a second network entity 504). The first subscription and second subscription may be provisioned by the same or different cellular service providers. The first subscription and the second subscription may be provisioned using the same radio access technology (RAT) or different RATs (e.g., LTE and/or 5G NR). As an example, the first network entity 502 may be an LTE or 5G NR base station, and the second network entity 504 may be an LTE or 5G NR base station, similar to those described above in relation to FIGS. 1 and 2. Each of the network entities 502 and 504 can be connected to a corresponding core network (e.g., the core network 102 of FIG. 1).

In one aspect, the multi-SIM UE 500 may have two SIMs (e.g., first SIM 506 and second SIM 508) that can be configured for dual-SIM dual active (DSDA) operations. In some aspects, one or both SIMs 506 and 508 may be implemented as a virtual SIM or embedded SIM (eSIM). In the DSDA mode, the multi-SIM UE 500 can actively and simultaneously communicate with different networks associated with different subscriptions using the two SIMs 506 and 508, respectively. Although two SIMs are used to exemplify the multi-SIM operation example herein, the UE 500 may perform multi-SIM operations using more than two SIMs in other examples.

In this example, the multi-SIM UE 500 may have separate radio frequency (RF) chains for supporting DSDA operations. For example, a first RF chain associated with the first SIM 506 can include a first antenna 510 (e.g., one or more antenna arrays or panels), a first transceiver (Tx/Rx) 512, and a first modem 514. A second RF chain associated with the second SIM 508 can include a second antenna 516 (e.g., one or more antenna arrays or panels), a second transceiver 518, and a second modem 520. The UE 500 may further include a controller 522 (e.g., a processor) that can control and/or configure the above-described antennas, SIMs, transceivers, and modems to support DSDA mode operations. In some aspects, the multi-SIM UE 500 can be equipped with one or more antenna arrays or panels (e.g., antennas 510 and 516), each including a number of antenna elements, and the antenna array can be configured to support DSDA operations using one or more antennas. In DSDA mode, the UE 500 may communicate with the first network entity 502 based on the first SIM 506. The controller 522 can read the information stored in the first SIM 506, and configure/control the first modem 514 and first transceiver 512 to wirelessly communicate with the first network entity 502 via the first antenna 510. Similarly, the UE 500 may communicate with the second network entity 504 based on the second SIM 508. That is, the controller 522 can read the information stored in the second SIM 508, and configure/control the second modem 520 and second transceiver 518 to wirelessly communicate with the second network entity 504 via the second antenna 516. Because the UE 500 has two modems 514/520, two transceivers 512/518, and two antennas 510/516, the UE 500 is able to simultaneously communicate with the first and second network entities of different subscriptions in the DSDA mode.

In some aspects, the multi-SIM UE 500 can use carrier aggregation (CA) to increase available data bandwidth or data rate for each SIM 506/508. Using CA, the UE can concatenate or combine multiple CCs to increase the bandwidth and/or data rate between the UE and the network. For example, the UE 500 can communicate with the network using a primary component carrier (PCC) and optionally one or more secondary CCs. The cell serving the PCC is called a primary cell (PCell), and the cell serving a secondary CC (SCC) is called a secondary cell (SCell). The UE 500 may simultaneously receive or transmit data on one or more CCs depending on its capabilities.

The first SIM 506 and second SIM 508 may operate in any of a variety of modes, such as a connected mode (also referred to as active mode), an idle mode, etc. During the idle mode, the UE does not transmit and receive data to the network of the corresponding SIM/subscription. During the connected mode, the UE can transmit and/or receive data to/from the network of the corresponding SIM/subscription using one or more CCs. In the DSDA mode, both SIMs 506 and 508 can operate in the connected mode.

In some scenarios, CCs used by different subscriptions/SIMs may experience a conflict situation (e.g., RF, hardware, and/or resource conflicts) that can prevent one or more CCs from being used while both SIMs/subscriptions are in the active mode. In one example, a primary CC used by the first SIM 506 (associated with a first subscription) may have a conflict with one or more secondary CCs used by the second SIM 508 (associated with a second subscription) while both SIMs are active. Therefore, when the UE changes the first SIM 506 from the idle mode to the connected mode using the primary CC during DSDA operations, the UE may need to stop the transmission (Tx) and reception (Rx) activities on the conflicting secondary CC(s) associated with the second SIM 508 that is also in the connected mode, when the first SIM has a higher priority than the second SIM. In this example, the UE 500 can mute or drop (i.e., stop Tx/Rx activities) the conflicting secondary CC(s) used by the second SIM, which may cause the network of the second subscription to deactivate the dropped or muted secondary CCs. However, the communication resources of the conflicting secondary CC(s) are wasted if the network cannot use (e.g., reallocate or reassign) the communication resources of the secondary CC(s) during the conflict between the SIMs/subscriptions.

Aspects of the disclosure provide techniques that enable a UE to indicate to a network entity when a CC is muted due to a conflict between subscriptions/SIMs in DSDA operations. With the information on the conflict, the network entity can reuse the resources of the muted CC for other UE(s). When the CC conflict no longer exists, the UE can inform the network entity, and the network entity may resume communication with the UE using the unmuted CC, if it is still available.

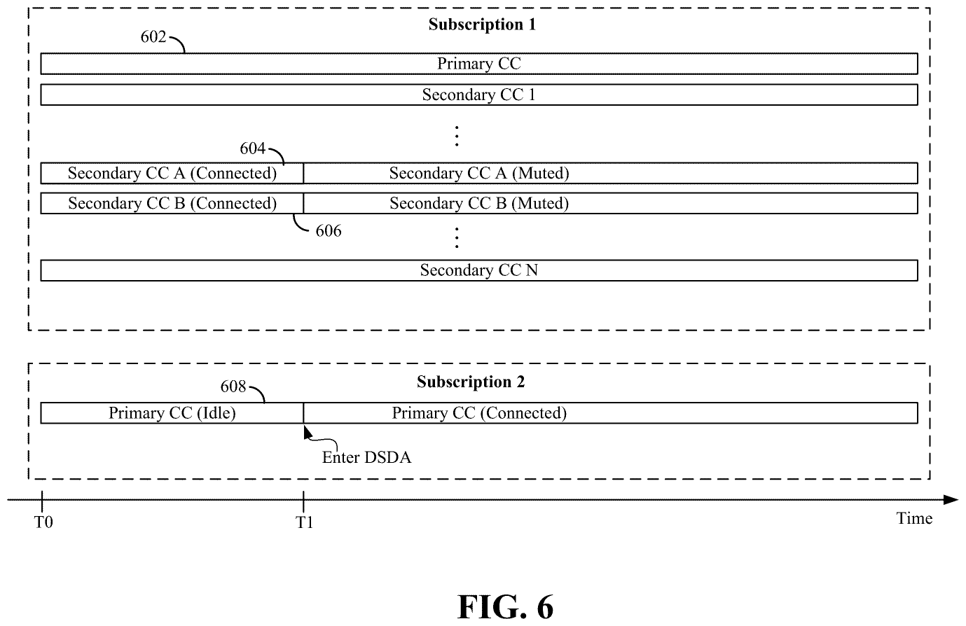

FIG. 6 is a diagram conceptually illustrating a process for managing CC conflicts during DSDA operations in accordance with some aspects. In one aspect, a UE (e.g., multi-SIM UE 500) can be connected with a first network associated with a first subscription and a second network associated with a second subscription. The first network and the second network may be similar to the wireless network described in relation to FIGS. 1 and 2. In one example, the UE can be in a connected mode with the first network (first subscription) using a first primary CC 602 and N secondary CCs (N is a positive integer with a value of 1 or larger). For example, the secondary CCs include a first secondary CC 604 (e.g., CC A) and a second secondary CC 606 (e.g., CC B). At time TO, the UE can be in an idle mode with the second network (second subscription) using a second primary CC 608. During the idle mode, the UE does not transmit/receive data to/from the second network using the second primary CC 608.

At time T1, the UE can enter the DSDA mode. For example, the UE can change from the idle mode to a connected mode with the second subscription using a carrier (e.g., second primary CC 608) that can create a conflict with one or more of the secondary CCs 604 and 606 (e.g., CC A and CC B) associated with the first subscription. In the connected mode with the second subscription, the UE can actively transmit and/or receive data using the second primary CC 608. When the UE is in the connected mode with both subscriptions, the UE is operating in DSDA mode. The conflict may be caused by communication resource conflicts between the CCs and/or capability limitation of the UE (RF capability). For example, the UE may be hardware and/or software limited to a certain number of active carriers. To manage the conflict, the UE may mute the conflicted secondary CCs (e.g., secondary CC A 604 and CC B 606) of the first subscription when the second primary CC 608 is in the connected mode. Muting the secondary CCs means stopping Tx and Rx activities on the muted CCs (e.g., CC A and CC B).

When the conflicted secondary CCs 604 and 606 of the subscription are muted, the UE can send a message or indication to a network entity (e.g., base station or gNB) of the first subscription. In one aspect, the UE can send the message in an uplink channel (e.g., PUSCH) medium access control (MAC) control element (CE) to a network entity (e.g., gNB of a PCell) of the first subscription, to indicate the muted CC(s) (e.g., secondary CCs A and B). In one example, the message may include a bitmap (or bitmask) for indicating whether the CCs are muted or not.

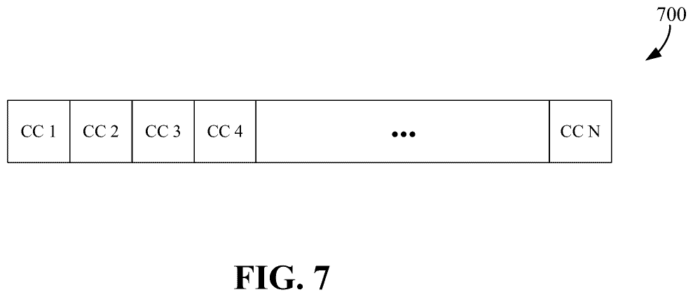

FIG. 7 is a drawing illustrating an exemplary bitmap 700 for indicating the status of CCs during DSDA operations according to one aspect of the disclosure. For example, the bitmap 700 can have a predetermined number of bits (e.g., N bits, N is an integer equal to 1 or larger). Each bit (e.g., bit 1 to bit N) of the bitmap 700 can indicate whether a corresponding CC (e.g., secondary CCs A and B) is muted or not. For example, a bit value of 0 can indicate a CC as muted, and a bit value of 1 can indicate a CC as unmuted. In one aspect, the bit positions can correspond to the SCC numbers configured by the network. In one example, the bit position to SCC mapping can be implicitly established by the network entity (e.g., a base station, gNB) at the time of adding the SCC(s) for use by the UE. The network entity (e.g., gNB) of the first subscription can use the resources (e.g., time, frequency, and/or spatial resources) of the muted CCs for other UE(s) that can use the resources for communication in the network. For example, a network entity can allocate the resources of the muted CCs to one or more other UEs for transmitting and/or receiving data while the secondary CCs are muted at a multi-SIM UE.

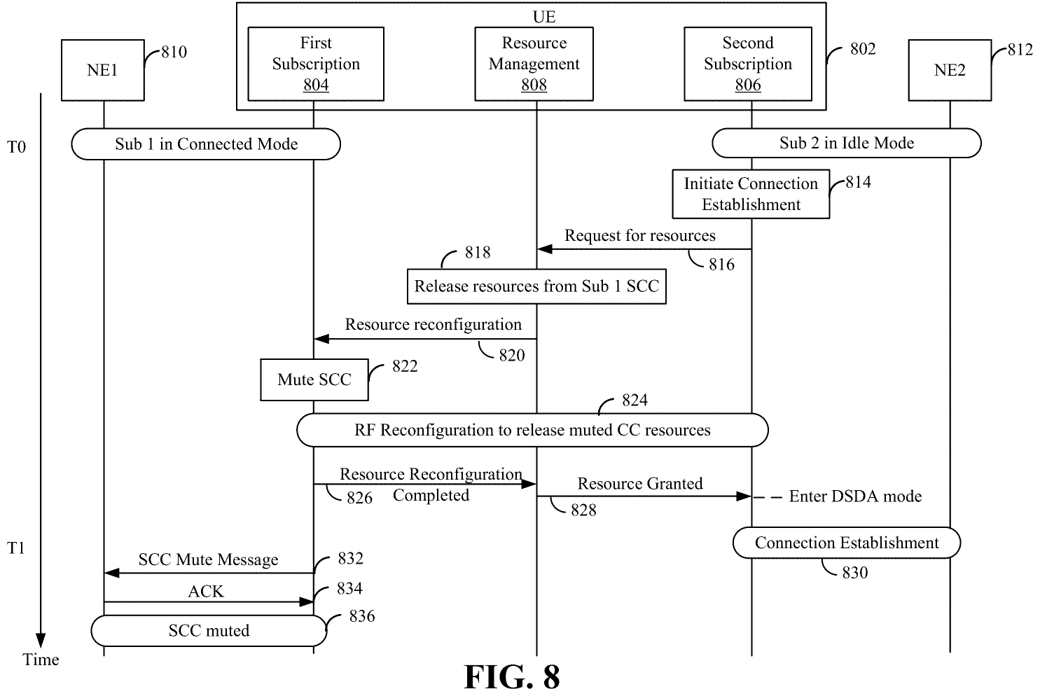

FIG. 8 is a diagram illustrating an exemplary process for managing a CC conflict at a multi-SIM UE according to some aspects. A multi-SIM UE 802 may be configured to use two subscriptions in DSDA mode. In one example, the UE 802 may be any of the UEs described above in relation to FIGS. 1, 2, and 4. In some aspects, the UE 802 may use various functional entities for multi-SIM operations, for example, a first subscription entity 804, a second subscription entity 806, and a resource management entity 808. These functional entities can be implemented by any combination of software and/or hardware components of the UE.

The multi-SIM UE 802 may be able to establish a connection (e.g., a communication link) with a first network entity 810 (NE1) of a first subscription and a connection (communication link) with a second network entity 812 (NE2) of a second subscription. For example, at a certain time (e.g., TO), the UE 802 can be in a connected mode with the first network entity 810 and an idle mode with the second network entity 812. In the connected mode, the UE 802 may communicate with the first network entity 810 using a first primary CC (e.g., primary CC 602) and one or more secondary CCs (e.g., secondary CCs 604 and 606).

At 814, the second subscription entity 806 can initiate connection establishment with the second network entity 812 to enter the DSDA mode. At 816, the second subscription entity 806 can send a request for resources (e.g., communication resources, RBs, REs, etc.) to the resource management entity 808. At 818, the resource management entity 808 can decide to release resources of one or more secondary CCs used by the first subscription in response to the request for resources for the second subscription. In one example, the resource management entity 808 may release the resources of two secondary CCs 604 and 606 of the first subscription that can be in conflict with the primary CC 608 of the second subscription when the UE is in the DSDA mode.

At 820, the resource management entity 808 can send a resource reconfiguration message to the first subscription entity 804 to indicate the release of the secondary CC resources. At 822, in response to the resource reconfiguration message, the first subscription entity 804 can mute the secondary CCs of which their communication resources (e.g., time, frequency, and/or spatial resources) are released. Once the secondary CCs are muted, the UE stops or suspends communication (e.g., transmit and receive) activities on the muted secondary CCs. At 824, the UE 802 can reconfigure its communication circuitry (e.g., RF chains) to complete the release of the resources of the muted secondary CCs.

At 826, the first subscription entity 804 can send a message to the resource management entity 808 to indicate that resource reconfiguration is completed by the first subscription entity 804. At 828, the resource management entity 808 can send a resource granted message to the second subscription entity 806 to indicate that the resources requested at 816 are granted for the second subscription. At this point, the UE can enter the DSDA mode with active connections (i.e., in connected mode) with both subscriptions. At 830, the UE 802 (e.g., second subscription entity 806) can complete connection establishment with the network entity 812 of the second subscription. In the DSDA mode, the UE 802 can have an active primary CC in connected mode with each subscription.

At 832, the first subscription entity 804 can send a message (e.g., SCC mute message) to the first network entity 810 of the first subscription to indicate that the secondary CCs are muted. In one example, the message may be an uplink MAC CE or a radio resource control (RRC) message. In some aspects, the message may be sent in an uplink shared channel (e.g., PUSCH). In some aspects, the SCC mute message may include a bitmap (e.g., bitmap 700) that indicates the status of each CC (e.g., secondary CC 1 to CC N) being muted or not. At 834, the first network entity 810 can send an acknowledgment message to the UE 802. At 836, the secondary CCs of the first subscription are muted by the first network entity. Since the secondary CCs are muted, the first network entity 810 can use the resources of the muted secondary CCs for other UE(s) in the network. For example, the first network entity 810 can schedule or allocate the resources to other UEs for UL and/or DL communication with the first network entity 810.

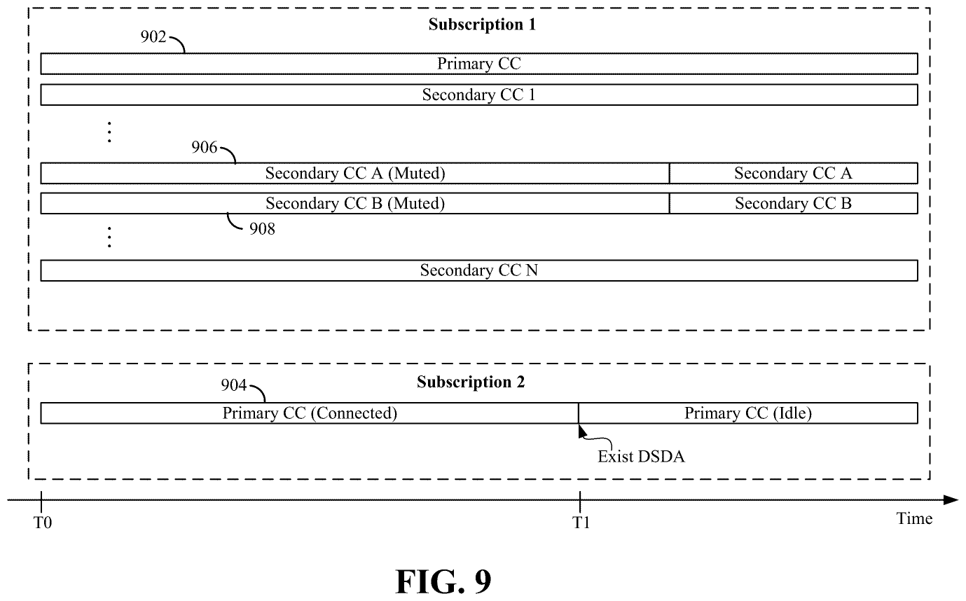

FIG. 9 is a diagram illustrating a process for managing CCs when exiting the DSDA mode according to some aspects. In the DSDA mode, a UE (e.g., multi-SIM UE 500) can be in a connected mode with multiple networks as described above in relation to FIGS. 6-8. At time T0, the UE is in the DSDA mode. For example, the UE can be in a connected mode with the first network (first subscription) using a first primary CC 902, and in a connected mode with the second network (second subscription) using a second primary CC 904. Due to conflict with the second primary CC 904, one or more secondary CCs 906 and 908 (e.g., secondary CCs A and B) of the first subscription are muted as described above in relation to FIGS. 6-8. When the secondary CCs are muted, the UE does not transmit and receive data using the muted secondary CCs and of the first subscription.

At time T1, the UE can exit the DSDA mode and enter an idle mode with the second subscription. For example, when the UE no longer actively transmits and/or receives data or signal using the second subscription, the UE can enter the idle mode and exits the DSDA mode. In this case, the UE stops transmitting and receiving data on the primary CC 904 of the second subscription. Because the primary CC 904 of the second subscription is no longer in conflict with the secondary CCs 906 and 908 (e.g., secondary CCs A and B) of the first subscription, the UE can unmute the secondary CCs 906 and 908. To that end, the UE can send a message or indication to the network entity of the first subscription. In one aspect, the UE can send the message in an uplink MAC CE to a network entity (e.g., a base station or gNB) of a PCell associated with the first subscription, to indicate the secondary CCs that have been unmuted. In one example, the message may include a bitmap (e.g., bitmap 700 of FIG. 7) configured to indicate whether each configured CC is muted or not. In some aspects, the network entity (e.g., gNB) of the first subscription may reuse the unmuted secondary CCs for active communication with the UE if the unmuted secondary CCs 906 and 908 are still available for the UE. Otherwise, the network may configure the UE to use different secondary CCs.

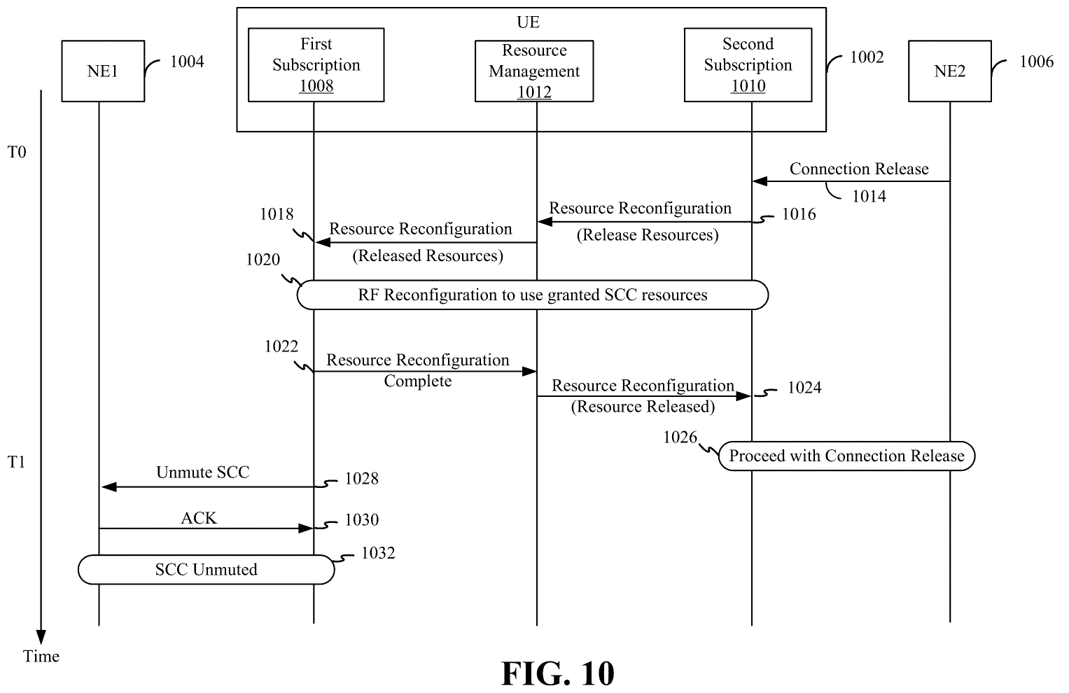

FIG. 10 is a diagram illustrating an exemplary process for managing a CC conflict at a multi-SIM UE exiting a DSDA mode according to some aspects. A multi-SIM UE 1002 may be configured to use two subscriptions for wireless communication in a DSDA mode. For example, the UE 1002 can communicate with a network entity (e.g., a first network entity 1004) of a first subscription and a network entity (e.g., a second network entity 1006) of a second subscription. In some aspects, the UE 1002 may have different functional entities that can be used for multi-SIM operations, for example, a first subscription entity 1008, a second subscription entity 1010, and a resource management entity 1012. These entities may be implemented using any combinations of software and/or hardware components of the UE.

At time T0, the UE 1002 can be in the DSDA mode. In this case, the UE 1002 may communicate with the first network entity 1004 (first subscription) using a primary CC (e.g., primary CC 802) and the second network entity 1006 (second subscription) using a primary CC (e.g., primary CC 904) that is in the connected mode. At 1014, the UE can exit the DSDA mode. For example, when the UE no longer actively transmits and/or receives data using the second subscription, the UE can request the second network entity to release the connection between the UE and the second network entity. In response, the second network entity 1006 can transmit a connection release message to the UE 1002 to release the active connection between the UE 1002 and the second network entity 1006. For example, the second subscription entity 1010 of the UE can process the connection release message. At 1016, the second subscription entity 1010 can send a resource reconfiguration message to the resource management entity 1012 to release the resources associated with the connection (e.g., primary CC 904) between the UE 1002 and the second network entity 1006.

At 1018, the resource management entity 1012 can transmit a resource reconfiguration message to the first subscription entity 1008 to indicate the resources released by the second subscription entity 1010. For example, the resources may be the resources associated with a primary CC and/or a secondary CC of the second subscription, and the released resources can be used by the UE to connect with the first network entity 1004 using one or more secondary CCs. At 1020, the UE 1002 can reconfigure its circuitry (e.g., RF circuitry) to use the newly available resources for activating one or more secondary CCs of the first subscription. The one or more secondary CCs may be previously muted secondary CCs as described above in relation to FIGS. 6-8.

At 1022, the first subscription entity 1008 can send a resource reconfiguration message to the resource management entity 1012 to indicate the completion of the reconfiguration. At 1024, the resource management entity 1012 can send a resource reconfiguration message to the second subscription entity 1010 to indicate that the resources of the primary CC are released. At 1026 (at time T1), the second subscription entity 1010 can proceed with completing the release of the connection (e.g., changing a primary CC from the connected mode to the idle mode) between the UE 1002 and the second network entity 1006.

At 1028, the first subscription entity 1008 can send a message to the first network entity 1004 to indicate that the previously muted secondary CCs (e.g., secondary CCs 906 and 908 of FIG. 9) have been unmuted by the UE. For example, the message may be an uplink MAC CE (e.g., unmute SCC). In one aspect, the unmute SCC message may include a bitmap with each bit indicating whether a corresponding secondary CC is unmuted or not. At 1030, the first network entity 1004 can send an acknowledgment for the unmute SCC message. At 1032, the UE 1002 and the first network entity 1004 can communicate with each other using the unmuted secondary CCs if they are still available for the UE 1002.

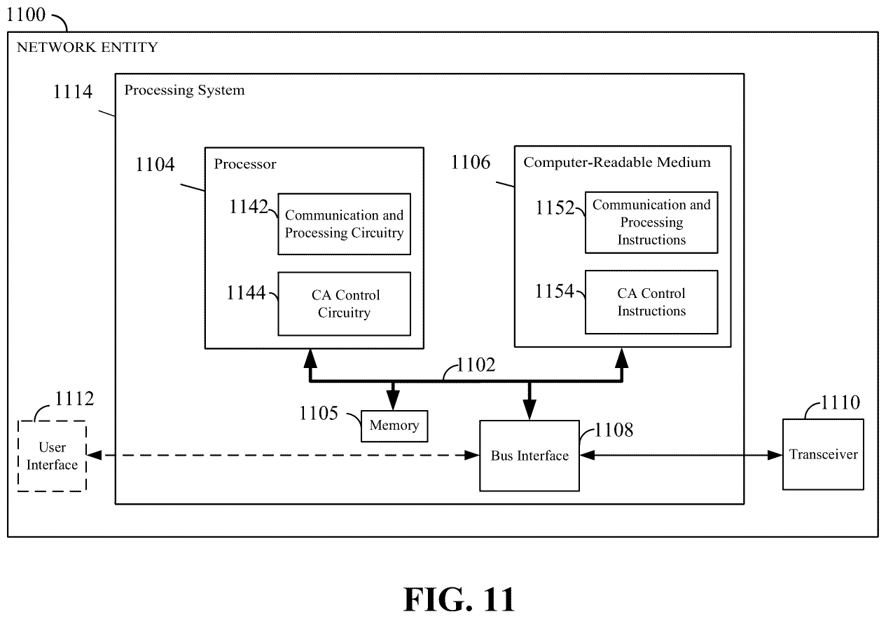

FIG. 11 is a block diagram illustrating an example of a hardware implementation for a network entity 1100 employing a processing system 1114. For example, the network entity 1100 may be a scheduling entity or network entity as illustrated in any one or more of FIGS. 1, 2, 5, 8, and/or 10.

The network entity 1100 may be implemented with a processing system 1114 that includes one or more processors 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1100 may be configured to perform any one or more of the functions described herein. That is, the processor 1104, as utilized in the network entity 1100, may be used to implement any one or more of the processes and procedures described and illustrated in FIGS. 6-10 and 12.

The processor 1104 may in some instances be implemented via a baseband or modem chip and in other implementations, the processor 1104 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, will not be described any further. A bus interface 1108 provides an interface between the bus 1102 and a transceiver 1110. The transceiver 1110 provides a communication interface or means for communicating with various other apparatus over a transmission medium. Depending upon the nature of the apparatus, a user interface 1112 (e.g., keypad, display, speaker, microphone, joystick, touch screen) may also be provided. Of course, such a user interface 1112 is optional, and may be omitted in some examples, such as a base station.

The processor 1104 is responsible for managing the bus 1102 and general processing, including the execution of software stored on the computer-readable medium 1106. The software, when executed by the processor 1104, causes the processing system 1114 to perform the various functions described below for any particular apparatus. The computer-readable medium 1106 and the memory 1105 may also be used for storing data that is manipulated by the processor 1104 when executing software.

One or more processors 1104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1106. The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1104 may include circuitry configured for various functions, including, for example, carrier aggregation (CA) control operations. For example, the circuitry may be configured to implement one or more of the functions described in relation to FIGS. 6-10 and 12.

In some aspects of the disclosure, the processor 1104 may include communication and processing circuitry 1142 configured for various functions, including for example communicating with a network core (e.g., a 5G core network), scheduled entities (e.g., UE), or any other entity, such as, for example, local infrastructure or an entity communicating with the network entity 1100 via the Internet, such as a network provider. In some examples, the communication and processing circuitry 1142 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1142 may include one or more transmit/receive chains. In addition, the communication and processing circuitry 1142 may be configured to receive and process uplink traffic and uplink control messages (e.g., similar to uplink traffic 116 and uplink control 118 of FIG. 1), transmit and process downlink traffic and downlink control messages (e.g., similar to downlink traffic 112 and downlink control 114). The communication and processing circuitry 1142 may be configured to communicate with a UE using a CA connection including a primary CC and one or more secondary CCs. The communication and processing circuitry 1142 may further be configured to execute communication and processing software 1152 stored on the computer-readable medium 1106 to implement one or more functions described herein.

In some implementations where the communication involves receiving information, the communication and processing circuitry 1142 may obtain information from a component of the network entity 1100 (e.g., from the transceiver 1110 that receives the information via radio frequency signaling or some other type of signaling suitable for the applicable communication medium), process (e.g., decode) the information, and output the processed information. For example, the communication and processing circuitry 1142 may output the information to another component of the processor 1104, to the memory 1105, or to the bus interface 1108. In some examples, the communication and processing circuitry 1142 may receive one or more of signals, messages, other information, or any combination thereof. In some examples, the communication and processing circuitry 1142 may receive information via one or more channels. In some examples, the communication and processing circuitry 1142 may include functionality for a means for receiving. In some examples, the communication and processing circuitry 1142 may include functionality for a means for processing, including a means for demodulating, a means for decoding, etc.

In some implementations where the communication involves sending (e.g., transmitting) information, the communication and processing circuitry 1142 may obtain information (e.g., from another component of the processor 1104, the memory 1105, or the bus interface 1108), process (e.g., modulate, encode, etc.) the information, and output the processed information. For example, the communication and processing circuitry 1142 may output the information to the transceiver 1110 (e.g., that transmits the information via radio frequency signaling or some other type of signaling suitable for the applicable communication medium). In some examples, the communication and processing circuitry 1142 may send one or more of signals, messages, other information, or any combination thereof. In some examples, the communication and processing circuitry 1142 may send information via one or more channels. In some examples, the communication and processing circuitry 1142 may include functionality for a means for sending (e.g., a means for transmitting). In some examples, the communication and processing circuitry 1142 may include functionality for a means for generating, including a means for modulating, a means for encoding, etc.

In some aspects of the disclosure, the processor 1104 may include CA control circuitry 1144 configured for CA configuration and control functions. In one aspect, the CA control circuitry 1144 can be configured to concatenate or combine multiple CCs (e.g., one primary CC and one or more secondary CCs) into one data channel between the network entity and a UE. The CA control circuitry 1144 can be configured to combine LTE and/or 5G carriers. In one aspect, the CA control circuitry 1144 can be configured to suspend communication on a secondary CC in response to an SCC mute message from a UE. In one aspect, the CA control circuitry 1144 can be configured to resume communication on a muted secondary CC in response to an SCC unmute message from a UE. In one aspect, the CA control circuitry 1144 can be configured to acknowledge an SCC mute/unmute message from a UE. The CA control circuitry 1144 may further be configured to execute CA control software 1154 stored on the computer-readable medium 1106 to implement one or more functions described herein.

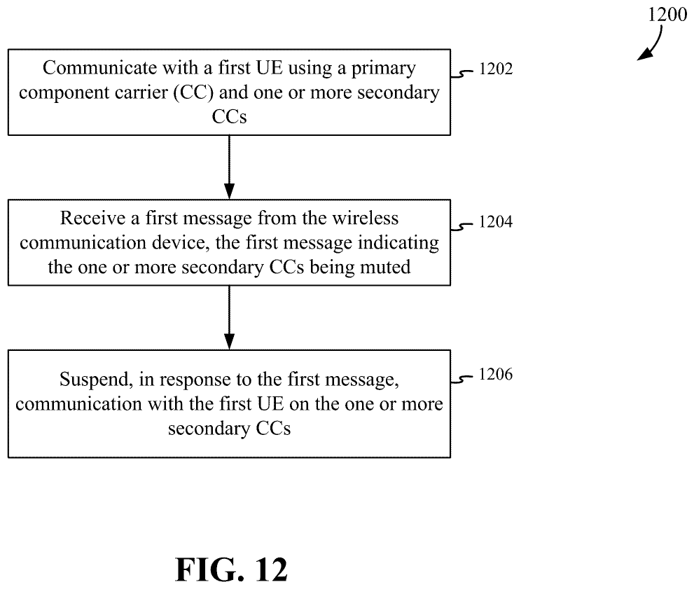

FIG. 12 is a flow chart illustrating an exemplary process 1200 for wireless communication at a network entity in accordance with some aspects of the present disclosure. As described below, some or all illustrated features may be omitted in a particular implementation within the scope of the present disclosure, and some illustrated features may not be required for the implementation of all examples. In some examples, the process 1200 may be carried out by the network entity 1100 illustrated in FIG. 11. In some examples, the process 1200 may be carried out by any suitable apparatus or means for carrying out the functions or algorithm described below.

At block 1202, a network entity (e.g., a scheduling entity, base station, or gNB) can communicate with a first UE using a primary CC and one or more secondary CCs. In one aspect, the communication and processing circuitry 1142 can provide a means to communicate with the first UE. In one example, the first UE may be the UE 802/1002 of FIG. 8/10. In one example, the primary CC may be the primary CC 602/902 of FIG. 6/9. The one or more secondary CCs may be the secondary CCs (e.g., secondary CCs A and B) described above in relation to FIGS. 6 and 9.

At block 1204, the network entity can receive a first message from the first UE, and the first message indicates the one or more secondary CCs being muted by the first UE. For example, the first message may be the SCC mute message 832 in FIG. 8. In one aspect, the communication and processing circuitry 1142 can provide a means to receive the first message. In one example, the first message may be a MAC CE configured to indicate the muted one or more secondary CCs. In another example, the first message may be an RRC message configured to indicate the muted one or more secondary CCs.

At block 1206, the network entity can suspend, in response to the first message, communication with the first UE on the one or more secondary CCs. By suspending communication, the network entity can stop transmitting and receiving data to and from the first UE on the one or more secondary CCs. In one aspect, the CA control circuitry 1144 can provide a means to suspend communication on the one or more secondary CCs. The network entity can still communicate with the first UE using the primary CC when the secondary CCs are suspended. In some aspects, the network entity can communicate with a second UE using communication resources associated with the muted/suspended one or more secondary CCs. In some aspects, the network entity can receive a second message from the first UE, and the second message indicates the one or more secondary CCs being unmuted at the first UE. Then, the network entity can resume, in response to the second message, communication with the first UE using the unmuted one or more secondary CCs, if available.

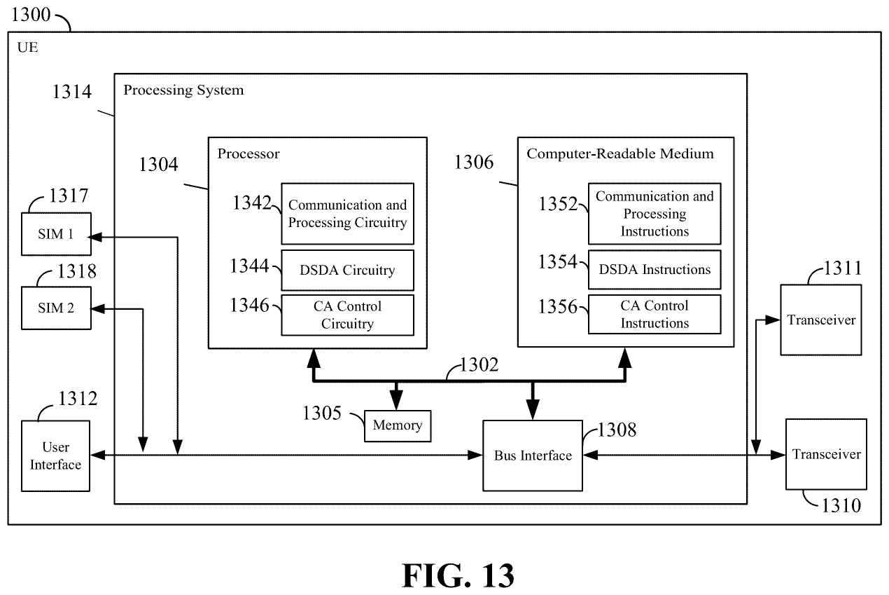

FIG. 13 is a conceptual diagram illustrating an example of a hardware implementation for an exemplary UE 1300 employing a processing system 1314. In accordance with various aspects of the disclosure, an element, or any portion of an element, or any combination of elements may be implemented with a processing system 1314 that includes one or more processors 1304. For example, the UE 1300 may be a scheduled entity or UE as illustrated in any one or more of FIGS. 1, 2, 5, 8, and/or 10.

The processing system 1314 may be substantially the same as the processing system 1114 illustrated in FIG. 11, including a bus interface 1308, a bus 1302, memory 1305, a processor 1304, and a computer-readable medium 1306. Furthermore, the UE 1300 may include one or more SIMs (e.g., SIMs 1317 and 1318), a user interface 1312, and transceivers (e.g., transceivers 1310 and 1311) substantially similar to those described above in FIG. 11. In some aspects, the UE 1300 can use the SIMs 1317 and 1318 to support DSDA communications with different subscriptions/networks. The processor 1304, as utilized in the UE 1300, may be used to implement any one or more of the processes described and illustrated in FIGS. 6-10 and 14.

In some aspects of the disclosure, the processor 1304 may include circuitry configured for various functions, including, for example, CA control operations in different multi-SIM modes. For example, the circuitry may be configured to implement one or more of the functions described in relation to FIGS. 6-10 and 14.

In some aspects of the disclosure, the processor 1304 may include communication and processing circuitry 1342 configured for various functions, including for example communicating with one or more network entities. In some examples, the communication and processing circuitry 1342 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1342 may include one or more transmit/receive chains (e.g., transceivers 1310 and 1311). In addition, the communication and processing circuitry 1342 may be configured to transmit and process uplink traffic and uplink control messages (e.g., similar to uplink traffic 116 and uplink control 118 of FIG. 1), receive and process downlink traffic and downlink control messages (e.g., similar to downlink traffic 112 and downlink control 114). The communication and processing circuitry 1342 may be configured to communicate with a network entity using CA including a primary CC and one or more secondary CCs. The communication and processing circuitry 1342 may further be configured to execute communication and processing software 1352 stored on the computer-readable medium 1306 to implement one or more functions described herein.

In some implementations where the communication involves receiving information, the communication and processing circuitry 1342 may obtain information from a component of the UE 1300 (e.g., from the transceiver 1310/1311 that receives the information via radio frequency signaling or some other type of signaling suitable for the applicable communication medium), process (e.g., decode) the information, and output the processed information. For example, the communication and processing circuitry 1342 may output the information to another component of the processor 1304, to the memory 1305, or to the bus interface 1308. In some examples, the communication and processing circuitry 1342 may receive one or more of signals, messages, other information, or any combination thereof. In some examples, the communication and processing circuitry 1342 may receive information via one or more channels. In some examples, the communication and processing circuitry 1342 may include functionality for a means for receiving. In some examples, the communication and processing circuitry 1342 may include functionality for a means for processing, including a means for demodulating, a means for decoding, etc.

In some implementations where the communication involves sending (e.g., transmitting) information, the communication and processing circuitry 1342 may obtain information (e.g., from another component of the processor 1304, the memory 1305, or the bus interface 1308), process (e.g., modulate, encode, etc.) the information, and output the processed information. For example, the communication and processing circuitry 1342 may output the information to the transceiver 1310/1311 (e.g., that transmits the information via radio frequency signaling or some other type of signaling suitable for the applicable communication medium). In some examples, the communication and processing circuitry 1342 may send one or more of signals, messages, other information, or any combination thereof. In some examples, the communication and processing circuitry 1342 may send information via one or more channels. In some examples, the communication and processing circuitry 1342 may include functionality for a means for sending (e.g., a means for transmitting). In some examples, the communication and processing circuitry 1342 may include functionality for a means for generating, including a means for modulating, a means for encoding, etc.

In some aspects of the disclosure, the processor 1304 may include DSDA circuitry 1344 configured for various DSDA functions. In one aspect, the DSDA circuitry 1344 can be configured to support simultaneous communication with different networks associated with different subscriptions using multiple SIMs (e.g., SIMs 1317 and 1318) and multiple transceivers (e.g., transceivers 1310 and 1311) as described herein. In one aspect, the DSDA circuitry 1344 can be configured to determine conflict between CCs of different subscriptions when the DSDA mode is enabled. For example, the DSDA circuitry 1344 can be configured to mute a CC during a conflict between subscriptions and unmute the CC when the conflict is over.

In some aspects of the disclosure, the processor 1304 may include CA control circuitry 1346 configured for CA configuration and control functions. In one aspect, the CA control circuitry 1346 can be configured to concatenate or combine multiple CCs (e.g., one primary CC and one or more secondary CCs) into one data channel between the UE and a network entity. The CA control circuitry 1346 can be configured to combine LTE and/or 5G carriers. In one aspect, the CA control circuitry 1346 can be configured to suspend communication on a secondary CC in response to a conflict between CCs of different subscriptions, and transmits an SCC mute message to a network entity. In one aspect, the CA control circuitry 1346 can be configured to resume communication on a muted secondary CC and transmits an SCC unmute message to a network entity. In one aspect, the CA control circuitry 1346 can be configured to receive an acknowledgment of the SCC mute/unmute message from a network entity. The CA control circuitry 1346 may further be configured to execute CA control software 1356 stored on the computer-readable medium 1306 to implement one or more functions described herein.

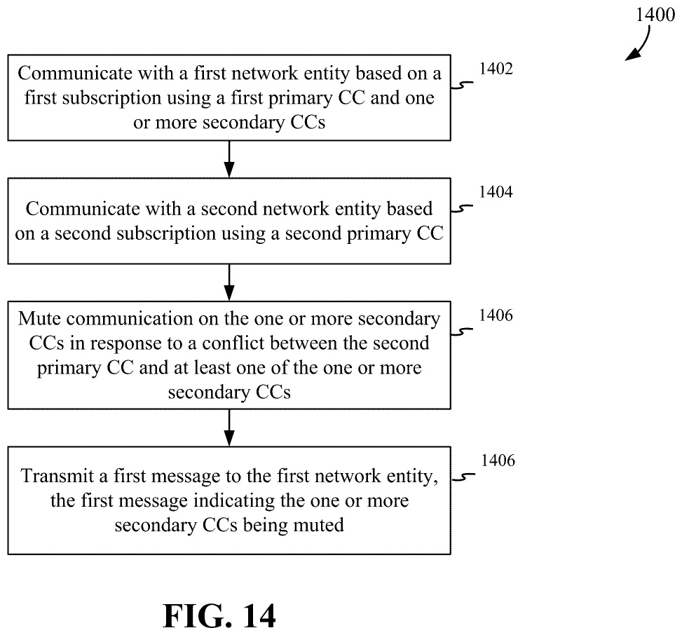

FIG. 14 is a flow chart illustrating an exemplary process 1400 for wireless communication at a UE in accordance with some aspects of the present disclosure. As described below, some or all illustrated features may be omitted in a particular implementation within the scope of the present disclosure, and some illustrated features may not be required for the implementation of all examples. In some examples, the process 1400 may be carried out by the UE 1300 illustrated in FIG. 13. In some examples, the process 1400 may be carried out by any suitable apparatus or means for carrying out the functions or algorithm described below.

At block 1402, a UE can communicate with a first network entity based on a first subscription using a first primary CC and one or more secondary CCs. In one aspect, the communication and processing circuitry 1342 together with the first SIM 1317 can provide a means to communicate with the first network entity via one of the transceivers 1310/1311. In one example, the first primary CC may be the primary CC 602 of FIG. 6 (or primary CC 902 of FIG. 9), and the secondary CCs may be the secondary CCs 604 and 606 of FIG. 6 (or secondary CCs 906 and 908 of FIG. 9). The CA control circuitry 1346 can provide a means to concatenate the first primary CC and secondary CCs for the first connection using carrier aggregation.

At block 1404, the UE can communicate with a second network entity based on a second subscription using a second primary CC. In one aspect, the communication and processing circuitry 1342 together with the second SIM 1318 can provide a means to communicate with the second network entity via one of the transceivers 1310/1311. In one example, the second primary CC may be the primary CC 602 of FIG. 6 (or primary CC 902 of FIG. 9). In one aspect, the UE can operate in the DSDA mode and maintains action connections (e.g., first connection and second connection) with the first and second subscriptions.

At block 1406, the UE can mute communication on the one or more secondary CCs in response to a conflict between the second primary CC and at least one of the one or more secondary CCs. The DSDA circuitry 1344 can provide a means to determine the conflict between the second primary CC and the one or more secondary CCs. For example, the UE can determine that the resources (e.g., time, frequency, and/or spatial resources) used by the second primary CC are in conflict with the resources used by the one or more secondary CCs. The DSDA circuitry 1344 can provide a means to mute the communication on the one or more secondary CCs. For example, the UE can stop transmitting and receiving activities on the one or more secondary CCs.

At block 1408, the UE can transmit a first message to the first network entity, and the first message indicates the one or more secondary CCs being muted. In one aspect, the communication and processing circuitry 1342 can provide a means to transmit the first message to the first network entity. For example, the first message may be an uplink MAC CE (e.g., SCC mute message 832 of FIG. 8) or an RRC message that indicates the muted secondary CC(s). In one example, the first message may include a plurality of bits (e.g., a bitmap), with each bit configured to indicate whether a corresponding secondary CC is muted or not. In response, the first network entity can use the resources of the muted secondary CC(s) for communicating with other UE(s) in the network.

In one configuration, the UE 1300 for wireless communication includes means for controlling CA operations in DSDA mode. In one aspect, the aforementioned means may be the processor 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 1, 2, 5, 8, and/or 10, and utilizing, for example, the processes and/or algorithms described herein in relation to FIGS. 6-10 and 14.

In a first aspect, a method of wireless communication at a user equipment (UE) is provided. The method comprises: communicating with a first network entity based on a first subscription using a first primary component carrier (CC) and one or more secondary CCs; communicating with a second network entity based on a second subscription using a second primary CC; muting communication on the one or more secondary CCs in response to a conflict between the second primary CC and at least one of the one or more secondary CCs; and transmitting a first message to the first network entity, the first message indicating the one or more secondary CCs being muted.

In a second aspect, alone or in combination with the first aspect, wherein the muting communication comprises: stopping transmitting and receiving activities on the one or more secondary CCs.

In a third aspect, alone or in combination with the first aspect, wherein the transmitting the first message comprises transmitting at least one of: a medium access control (MAC) control element (CE) configured to indicate the muted one or more secondary CCs; or a radio resource control (RRC) message configured to indicate the muted one or more secondary CCs.

In a fourth aspect, alone or in combination with any of the first to third aspects, wherein the first message comprises a plurality of bits, each bit configured to indicate whether a corresponding secondary CC of the one or more secondary CCs is muted or not.

In a fifth aspect, alone or in combination with any of the first to third aspects, the method further comprises: changing the second subscription from a connected mode to an idle mode; unmuting communication on the one or more secondary CCs in response to the second subscription being changed to the idle mode; and transmitting a second message to the first network entity, the second message indicating the unmuted one or more secondary CCs.

In a sixth aspect, alone or in combination with the fifth aspect, wherein the unmuting communication comprises: resuming transmitting and receiving activities on the one or more secondary CCs.

In a seventh aspect, alone or in combination with the fifth aspect, wherein the transmitting the second message comprises transmitting at least one of: a medium access control (MAC) control element (CE) configured to indicate the unmuted one or more secondary CCs; or a radio resource control (RRC) message configured to indicate the unmuted one or more secondary CCs.

In an eighth aspect, alone or in combination with the fifth aspect, the method further comprises: receiving, from the first network entity, an acknowledgement of the second message indicating the unmuted one or more secondary CCs.

In a nineth aspect, alone or in combination with any of the first to third aspects, wherein the UE communicated with the first network entity and the second network entity, respectively, in a dual-SIM dual active (DSDA) mode.

In a tenth aspect, a user equipment (UE) for wireless communication is provided. The UE comprises a memory stored with executable code and a processor coupled to the memory. The processor is configured by the executable code to: communicate with a first network entity based on a first subscription using a first primary component carrier (CC) and one or more secondary CCs; communicate with a second network entity based on a second subscription using a second primary CC; mute communication on the one or more secondary CCs in response to a conflict between the second primary CC and at least one of the one or more secondary CCs; and transmit a first message to the first network entity, the first message indicating the one or more secondary CCs being muted.

In an eleventh aspect, alone or in combination with the tenth aspect, wherein, to mute communication, the processor is further configured to stop transmitting and receiving activities on the one or more secondary CCs.

In a twelfth aspect, alone or in combination with the tenth aspect, wherein, to transmit the first message, the processor is further configured to transmit at least one of: a medium access control (MAC) control element (CE) configured to indicate the muted one or more secondary CCs; or a radio resource control (RRC) message configured to indicate the muted one or more secondary CCs.

In a thirteenth aspect, alone or in combination with any of the tenth to twelfth aspects, wherein the first message comprises a plurality of bits, each bit configured to indicate whether a corresponding secondary CC of the one or more secondary CCs is muted or not.

In a fourteenth aspect, alone or in combination with any of the tenth to twelfth aspects, wherein the processor is further configured to: change the second subscription from a connected mode to an idle mode; unmute communication on the one or more secondary CCs in response to the second subscription being changed to the idle mode; and transmit a second message to the first network entity, the second message indicating the unmuted one or more secondary CCs.

In a fifteenth aspect, alone or in combination with the fourteenth aspect, wherein, to unmute communication, the processor is further configured to: resume transmitting and receiving activities on the one or more secondary CCs.

In a sixteenth aspect, alone or in combination with the fourteenth aspect, wherein the transmitting the second message comprises transmitting at least one of: a medium access control (MAC) control element (CE) configured to indicate the unmuted one or more secondary CCs; or a radio resource control (RRC) message configured to indicate the unmuted one or more secondary CCs.

In a seventeenth aspect, alone or in combination with the fourteenth aspect, wherein the processor is further configured to: receive, from the first network entity, an acknowledgement of the second message indicating the unmuted one or more secondary CCs.

In an eighteenth aspect, alone or in combination with any of the tenth to twelfth aspects, wherein the processor is further configured to communicate with the first network entity and the second network entity, respectively, in a dual-SIM dual active (DSDA) mode.

In a nineteenth aspect, a method of wireless communication at a network entity is provided. The method comprises: communicating with a first user equipment (UE) using a primary component carrier (CC) and one or more secondary CCs; receiving a first message from the first UE, the first message indicating the one or more secondary CCs being muted at the first UE; and suspending, in response to the first message, communication with the first UE on the one or more secondary CCs.

In a twentieth aspect, alone or in combination with the nineteenth aspect, the method further comprises: communicating with a second UE using communication resources associated with the muted one or more secondary CCs in response to suspending the communication with the first UE.

In a twenty-first aspect, alone or in combination with the nineteenth aspect, wherein the receiving the first message comprises receiving at least one of: a medium access control (MAC) control element (CE) configured to indicate the muted one or more secondary CCs; or a radio resource control (RRC) message configured to indicate the muted one or more secondary CCs.

In a twenty-second aspect, alone or in combination with any of the nineteenth to twenty-first aspects, the method further comprises: receiving a second message from the first UE, the second message indicating the one or more secondary CCs being unmuted at the first UE; and resuming, in response to the second message, communication with the first UE using the unmuted one or more secondary CCs.

In a twenty-third aspect, alone or in combination with the twenty-second, wherein the receiving the second message comprises receiving at least one of: a medium access control (MAC) control element (CE) configured to indicate the unmuted one or more secondary CCs; or a radio resource control (RRC) message configured to indicate the unmuted one or more secondary CCs.

In a twenty-fourth aspect, alone or in combination with any of the nineteenth to twenty-first aspects, wherein the first message comprises a plurality of bits, each bit indicating whether a corresponding secondary CC of the one or more secondary CCs is muted or not.

In a twenty-fifth aspect, a network entity for wireless communication is provided. The network entity comprises a memory stored with executable code and a processor coupled to the memory. Wherein the processor is configured by the executable code to: communicate with a first user equipment (UE) using a primary component carrier (CC) and one or more secondary CCs; receive a first message from the first UE, the first message indicating the one or more secondary CCs being muted at the first UE; and suspend, in response to the first message, communication with the first UE on the one or more secondary CCs.

In a twenty-sixth aspect, alone or in combination with the twenty-fifth aspect, wherein the processor is further configured to: communicate with a second UE using communication resources associated with the muted one or more secondary CCs in response to suspending the communication with the first UE.

In a twenty-seventh aspect, alone or in combination with the twenty-fifth aspect, wherein, to receive the first message, the processor is further configured to receive at least one of: a medium access control (MAC) control element (CE) configured to indicate the muted one or more secondary CCs; or a radio resource control (RRC) message configured to indicate the muted one or more secondary CCs.

In a twenty-eighth aspect, alone or in combination with any of the twenty-fifth to twenty-seventh aspects, wherein the processor is further configured to: receive a second message from the first UE, the second message indicating the one or more secondary CCs being unmuted at the first UE; and resume, in response to the second message, communication with the first UE using the unmuted one or more secondary CCs.

In a twenty-ninth aspect, alone or in combination with the twenty-eighth aspect, wherein, to receive the second message, the processor is further configured to receive at least one of: a medium access control (MAC) control element (CE) configured to indicate the unmuted one or more secondary CCs; or a radio resource control (RRC) message configured to indicate the unmuted one or more secondary CCs.

In a thirtieth aspect, alone or in combination with any of the twenty-fifth to twenty-seventh aspects, wherein the first message comprises a plurality of bits, each bit indicating whether a corresponding secondary CC of the one or more secondary CCs is muted or not.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication at a user equipment (UE), comprising:
communicating with a first network entity based on a first subscription using a first primary component carrier (CC) and one or more secondary CCs;
communicating with a second network entity based on a second subscription using a second primary CC;
muting communication on the one or more secondary CCs in response to a conflict between the second primary CC and at least one of the one or more secondary CCs; and
transmitting a first message to the first network entity, the first message indicating the one or more secondary CCs being muted.

2. The method of claim 1, wherein the muting communication comprises:
stopping transmitting and receiving activities on the one or more secondary CCs.

3. The method of claim 1, wherein the transmitting the first message comprises transmitting at least one of:
a medium access control (MAC) control element (CE) configured to indicate the muted one or more secondary CCs; or
a radio resource control (RRC) message configured to indicate the muted one or more secondary CCs.

4. The method of claim 3, wherein the first message comprises a plurality of bits, each bit configured to indicate whether a corresponding secondary CC of the one or more secondary CCs is muted or not.

5. The method of claim 1, further comprising:
changing the second subscription from a connected mode to an idle mode;
unmuting communication on the one or more secondary CCs in response to the second subscription being changed to the idle mode; and
transmitting a second message to the first network entity, the second message indicating the unmuted one or more secondary CCs.

6. The method of claim 5, wherein the unmuting communication comprises:
resuming transmitting and receiving activities on the one or more secondary CCs.

7. The method of claim 5, wherein the transmitting the second message comprises transmitting at least one of:
a medium access control (MAC) control element (CE) configured to indicate the unmuted one or more secondary CCs; or
a radio resource control (RRC) message configured to indicate the unmuted one or more secondary CCs.

8. The method of claim 5, further comprising:
receiving, from the first network entity, an acknowledgement of the second message indicating the unmuted one or more secondary CCs.

9. The method of claim 1, wherein the UE communicated with the first network entity and the second network entity, respectively, in a dual-SIM dual active (DSDA) mode.

10. A user equipment (UE) for wireless communication, comprising:
a memory stored with executable code; and
a processor coupled to the memory, wherein the processor is configured by the executable code to:
communicate with a first network entity based on a first subscription using a first primary component carrier (CC) and one or more secondary CCs;
communicate with a second network entity based on a second subscription using a second primary CC;
mute communication on the one or more secondary CCs in response to a conflict between the second primary CC and at least one of the one or more secondary CCs; and
transmit a first message to the first network entity, the first message indicating the one or more secondary CCs being muted.

11. The UE of claim 10, wherein, to mute communication, the processor is further configured to:
stop transmitting and receiving activities on the one or more secondary CCs.

12. The UE of claim 10, wherein, to transmit the first message, the processor is further configured to transmit at least one of:
a medium access control (MAC) control element (CE) configured to indicate the muted one or more secondary CCs; or
a radio resource control (RRC) message configured to indicate the muted one or more secondary CCs.

13. The UE of claim 12, wherein the first message comprises a plurality of bits, each bit configured to indicate whether a corresponding secondary CC of the one or more secondary CCs is muted or not.

14. The UE of claim 10, wherein the processor is further configured to:
change the second subscription from a connected mode to an idle mode;
unmute communication on the one or more secondary CCs in response to the second subscription being changed to the idle mode; and
transmit a second message to the first network entity, the second message indicating the unmuted one or more secondary CCs.

15. The UE of claim 14, wherein, to unmute communication, the processor is further configured to:
resume transmitting and receiving activities on the one or more secondary CCs.

16. The UE of claim 14, wherein the transmitting the second message comprises transmitting at least one of:
a medium access control (MAC) control element (CE) configured to indicate the unmuted one or more secondary CCs; or
a radio resource control (RRC) message configured to indicate the unmuted one or more secondary CCs.

17. The UE of claim 14, wherein the processor is further configured to:
receive, from the first network entity, an acknowledgement of the second message indicating the unmuted one or more secondary CCs.

18. The UE of claim 10, wherein the processor is further configured to communicate with the first network entity and the second network entity, respectively, in a dual-SIM dual active (DSDA) mode.

19. A method of wireless communication at a network entity, comprising:
communicating with a first user equipment (UE) using a primary component carrier (CC) and one or more secondary CCs;
receiving a first message from the first UE, the first message indicating the one or more secondary CCs being muted at the first UE; and
suspending, in response to the first message, communication with the first UE on the one or more secondary CCs.

20. The method of claim 19, further comprising:
communicating with a second UE using communication resources associated with the muted one or more secondary CCs in response to suspending the communication with the first UE.

21. The method of claim 19, wherein the receiving the first message comprises receiving at least one of:
a medium access control (MAC) control element (CE) configured to indicate the muted one or more secondary CCs; or
a radio resource control (RRC) message configured to indicate the muted one or more secondary CCs.

22. The method of claim 19, further comprising:
receiving a second message from the first UE, the second message indicating the one or more secondary CCs being unmuted at the first UE; and
resuming, in response to the second message, communication with the first UE using the unmuted one or more secondary CCs.

23. The method of claim 22, wherein the receiving the second message comprises receiving at least one of:
a medium access control (MAC) control element (CE) configured to indicate the unmuted one or more secondary CCs; or
a radio resource control (RRC) message configured to indicate the unmuted one or more secondary CCs.

24. The method of claim 19, wherein the first message comprises a plurality of bits, each bit indicating whether a corresponding secondary CC of the one or more secondary CCs is muted or not.

25. A network entity for wireless communication, comprising:
a memory stored with executable code; and
a processor coupled to the memory, wherein the processor is configured by the executable code to:
communicate with a first user equipment (UE) using a primary component carrier (CC) and one or more secondary CCs;
receive a first message from the first UE, the first message indicating the one or more secondary CCs being muted at the first UE; and
suspend, in response to the first message, communication with the first UE on the one or more secondary CCs.

26. The network entity of claim 25, wherein the processor is further configured to:
communicate with a second UE using communication resources associated with the muted one or more secondary CCs in response to suspending the communication with the first UE.

27. The network entity of claim 25, wherein, to receive the first message, the processor is further configured to receive at least one of:
a medium access control (MAC) control element (CE) configured to indicate the muted one or more secondary CCs; or
a radio resource control (RRC) message configured to indicate the muted one or more secondary CCs.

28. The network entity of claim 25, wherein the processor is further configured to:
receive a second message from the first UE, the second message indicating the one or more secondary CCs being unmuted at the first UE; and
resume, in response to the second message, communication with the first UE using the unmuted one or more secondary CCs.

29. The network entity of claim 28, wherein, to receive the second message, the processor is further configured to receive at least one of:
a medium access control (MAC) control element (CE) configured to indicate the unmuted one or more secondary CCs; or
a radio resource control (RRC) message configured to indicate the unmuted one or more secondary CCs.

30. The network entity of claim 25, wherein the first message comprises a plurality of bits, each bit indicating whether a corresponding secondary CC of the one or more secondary CCs is muted or not.
